(19) United States
(12) Patent Application Publication
(10) Pub. No.: US 2018/0279384 A1
(43) Pub. Date: Sep. 27, 2018

(54) Two-Phase Backoff for Access Procedure in Wireless Communication Systems

(71) Applicant: MEDIATEK INC., Hsinchu (TW)

(72) Inventors: Chia-Chun Hsu, Hsinchu (TW); Johan Johansson, Kungsangen (SE)

(21) Appl. No.: 15/928,091

(22) Filed: Mar. 22, 2018

Related U.S. Application Data
(60) Provisional application No. 62/476,691, filed on Mar. 24, 2017.

(51) Int. Cl. H04W 74/08; H04W 74/00; H04W 52/36

(52) U.S. Cl. CPC H04W 74/0841; H04W 52/367; H04W 74/006

(57) ABSTRACT

A two-phase backoff mechanism for LTE access procedure is proposed where backoff handling is applied differently in two separate phases. During the first phase, network-controlled reattempts involves adaptation to radio conditions. Reattempts due to collisions, ramping of power and other robustness parameters needed to compensate for unpredictable conditions can be handled in the first phase. During the second phase, UE-controlled reattempts continues for other conditions. UE can reattempt at a lesser rate to alleviate the worsening of the load and interference situation. As a result, backoff handling is optimized towards LTE access procedures.

### CROSS REFERENCE TO RELATED APPLICATIONS

This application claims priority under 35 U.S.C. § 119 from U.S. Provisional Application No. 62/476,691, entitled “Two-Phase Backoff,” filed on Mar. 24, 2017, the subject matter of which is incorporated herein by reference.

### TECHNICAL FIELD

The disclosed embodiments relate generally to wireless network communications, and, more particularly, to functionality for reattempts of an access procedure in wireless communication systems.

### BACKGROUND

A Long-Term Evolution (LTE) system offers high peak data rates, low latency, improved system capacity, and low operating cost resulting from simple network architecture. An LTE system also provides seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred as user equipments (UEs). Enhancements to LTE systems are considered so that they can meet or exceed International Mobile Telecommunications Advanced (IMT-Advanced) fourth generation (4G) standard. Multiple access in the downlink is achieved by assigning different sub-bands (i.e., groups of subcarriers, denoted as resource blocks (RBs)) of the system bandwidth to individual users based on their existing channel condition. In LTE networks, Physical Downlink Control Channel (PDCCH) is used for downlink (DL) scheduling or uplink (UL) scheduling of Physical Downlink Shared Channel (PDSCH) or Physical Uplink Shared Channel (PUSCH) transmission.

In order to synchronize with the network and to gain access to the network, a random-access procedure is used. A UE will first try to attach to the network via a separate channel PRACH (Physical Random-Access Channel) for initial access to the network. Contention-based random access can be used by any accessing UE in need of an uplink connection while Contention-free random access can be used in areas where low latency is required. In both procedures, a random-access preamble is transmitted by an accessing UE over the PRACH. If multiple UEs happen to initiate the random-access procedure at the same time, a collision occurs when the multiple UEs pick the same preamble and the same PRACH resource.

Current 3GPP LTE random access procedure involves reattempts and also a backoff mechanism to decrease the reattempt rate at high load. UEs will reattempt the preamble transmission with the backoff mechanism, e.g., after waiting a certain amount of time. However, the backoff handling does not discriminate between initial reattempts with power ramping and subsequent reattempts, leading to unnecessarily high impact of applying backoff. Further, other technologies for unlicensed spectrum such as Wi-Fi also apply backoff, but also do not discriminate between initial and subsequent reattempts, making it unsuitable for reattempts with robustness increase or power ramping in LTE systems. A solution is sought to optimize the backoff handling mechanism during the LTE random access procedure.

### SUMMARY

A two-phase backoff mechanism for LTE access procedures is proposed where backoff handling is applied differently in two separate phases. During the first phase, network-controlled reattempts involves adaptation to radio conditions. Reattempts due to collisions, ramping of power and other robustness parameters needed to compensate for unpredictable conditions can be handled in the first phase. During the second phase, UE-controlled reattempts continues for other conditions. UE can reattempt at a lesser rate to alleviate the worsening of the load and interference situation. As a result, backoff handling is optimized towards LTE access procedures.

In one embodiment, a user equipment (UE) receives access configuration information from a base station in a wireless communications network. The UE performs a first phase of an access procedure with the base station using a first set of parameters including a first backoff time received from the access configuration information. The UE determines a list of conditions for switching to a second phase of the access procedure if the UE fails gaining access during the first phase. The UE performs a second phase of the access procedure using a second set of parameters including a second backoff time determined by the UE.

Other embodiments and advantages are described in the detailed description below. This summary does not purport to define the invention. The invention is defined by the claims.

### BRIEF DESCRIPTION OF THE DRAWINGS

FIG. 1 illustrates a wireless communications system with two-phase backoff handling for random-access procedures in accordance with a novel aspect.

FIG. 2 is a simplified block diagram of a wireless transmitting device and a receiving device in accordance with a novel aspect.

FIG. 3A illustrates an example of an access procedure in LTE networks.

FIG. 3B illustrates a first example of an error case during a random-access procedure where reattempts are performed.

FIG. 3C illustrates a second example of an error case during a random-access procedure where reattempts are performed.

FIG. 4 illustrates a random-access procedure with two-phase backoff handling in accordance with a novel aspect of the present invention.

FIG. 5 illustrates different examples of triggering conditions for switching from phase-1 to phase-2 backoff handling.

FIG. 6 is flow chart of a method of two-phase backoff handling for access procedures in accordance with one novel aspect.

### DETAILED DESCRIPTION

Reference will now be made in detail to some embodiments of the invention, examples of which are illustrated in the accompanying drawings.

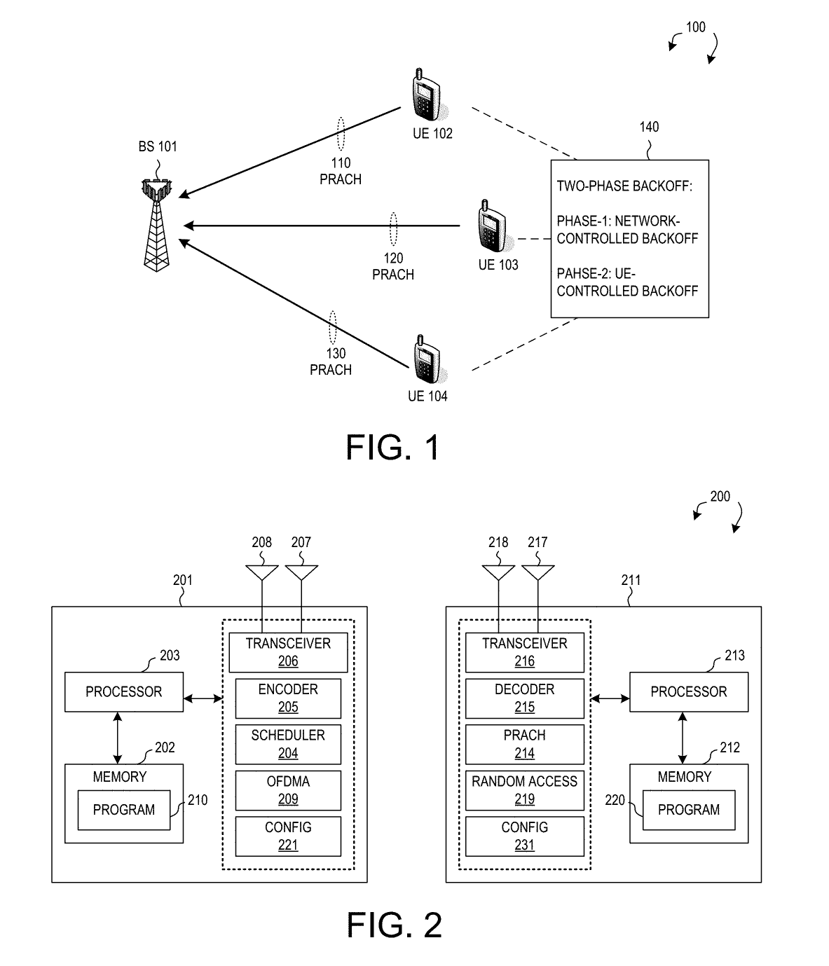

FIG. 1 illustrates a wireless communications system 100 with two-phase backoff handling for random-access procedures in accordance with a novel aspect. Mobile communication network 100 is an OFDM/OFDMA system comprising a base station BS 101 and a plurality of user equipments including UE 102, UE 103, and UE 104. In 3GPP LTE systems based on OFDMA downlink, the radio resource is partitioned into subframes in time domain, each subframe is comprised of two slots. Each OFDMA symbol further consists of a number of OFDMA subcarriers in frequency domain depending on the system bandwidth. The basic unit of the resource grid is called Resource Element (RE), which spans an OFDMA subcarrier over one OFDMA symbol.

When there is a downlink packet to be sent from eNodeB to UE, each UE gets a downlink assignment, e.g., a set of radio resources in a physical downlink shared channel (PDSCH). When a UE needs to send a packet to eNodeB in the uplink, the UE gets a grant from the eNodeB that assigns a physical uplink shared channel (PUSCH) consisting of a set of uplink radio resources. The UE gets the downlink or uplink scheduling information from a physical downlink control channel (PDCCH) that is targeted specifically to that UE. In addition, broadcast control information is also sent in PDCCH to all UEs in a cell. The downlink or uplink scheduling information and the broadcast control information, carried by PDCCH, is referred to as downlink control information (DCI). The uplink control information (UCI) including HARQ ACK/NACK, CQI, MIMO feedback, scheduling requests is carried by a physical uplink control channel (PUCCH) or PUSCH if the UE has data or RRC signaling.

Furthermore, physical random-access channel (PRACH) is a separate channel allocated to each UE to synchronize with the network and to gain access to the base station. Current 3GPP LTE random access procedure involves reattempts and also a backoff function to decrease the reattempt rate at high load. However, the backoff handling does not discriminate between initial reattempts with power ramping and subsequent reattempts, leading to unnecessarily high impact of applying backoff. Technologies for unlicensed spectrum such as Wi-Fi also apply backoff, but also do not discriminate between initial and subsequent reattempts, making it unsuitable for reattempts with robustness increase or power ramping.

In accordance with a novel aspect, a two-phase backoff mechanism for LTE access procedures is proposed where backoff handling is applied differently in two separate phases. During the first phase, network-controlled reattempts involves adaptation to radio conditions. Reattempts due to collisions, ramping of power and other robustness parameters needed to compensate for unpredictable conditions can be handled in the first phase. During the second phase, UE-controlled reattempts continues for other conditions. UE can reattempt at a lesser rate to alleviate the worsening of the load and interference situation. As a result, backoff handling is optimized towards LTE access procedures.

In the example of FIG. 1, each UE transmits random access preambles over allocated PRACH resources to gain initial access to the network. For example, UE 102 transmits preambles over PRACH 110 for uplink random access, UE 103 transmits preambles over PRACH 120 for uplink random access, and UE 104 transmits preambles over PRACH 130 for uplink random access. In LTE, PRACH resources are configured for a cell through the system information block (SIB) message. Through SIB broadcasting, each UE also receives information and parameters related to access allowed by BS 101, e.g., timeout values and backoff timers for reattempts. When access failed due to collision or error for a UE, the UE performs reattempts with backoff. As depicted by 140, the UE first enters the first phase, where backoff parameters are provided and controlled by the network. Upon certain condition is detected and access is still unsuccessful, the UE then enters the second phase, where backoff parameters are determined and controlled by the UE itself.

FIG. 2 is a simplified block diagram of wireless devices 201 and 211 in accordance with a novel aspect. For wireless device 201 (e.g., a transmitting device), antennae 207 and 208 transmit and receive radio signal. RF transceiver module 206, coupled with the antennae, receives RF signals from the antennae, converts them to baseband signals and sends them to processor 203. RF transceiver 206 also converts received baseband signals from the processor, converts them to RF signals, and sends out to antennae 207 and 208. Processor 203 processes the received baseband signals and invokes different functional modules and circuits to perform features in wireless device 201. Memory 202 stores program instructions and data 210 to control the operations of device 201.

Similarly, for wireless device 211 (e.g., a receiving device), antennae 217 and 218 transmit and receive RF signals. RF transceiver module 216, coupled with the antennae, receives RF signals from the antennae, converts them to baseband signals and sends them to processor 213. The RF transceiver 216 also converts received baseband signals from the processor, converts them to RF signals, and sends out to antennae 217 and 218. Processor 213 processes the received baseband signals and invokes different functional modules and circuits to perform features in wireless device 211. Memory 212 stores program instructions and data 220 to control the operations of the wireless device 211.

The wireless devices 201 and 211 also include several functional modules and circuits that can be implemented and configured to perform embodiments of the present invention. In the example of FIG. 2, wireless device 201 is a transmitting device that includes an encoder 205, a scheduler 204, an OFDMA module 209, and a configuration circuit 221. Wireless device 211 is a receiving device that includes a decoder 215, a PRACH circuit 214, a random-access circuit 219, and a configuration circuit 231. Note that a wireless device may be both a transmitting device and a receiving device. The different functional modules and circuits can be implemented and configured by software, firmware, hardware, and any combination thereof. The function modules and circuits, when executed by the processors 203 and 213 (e.g., via executing program codes 210 and 220), allow transmitting device 201 and receiving device 211 to perform embodiments of the present invention.

In one example, the transmitting device (a base station) configures radio resource (PRACH) for UEs via configuration circuit 221, schedules downlink and uplink transmission for UEs via scheduler 204, encodes data packets to be transmitted via encoder 205 and transmits OFDM radio signals via OFDM module 209. The receiving device (a user equipment) obtains allocated radio resources for PRACH via configuration circuit 231, receives and decodes downlink data packets via decoder 215, and transmits random access preambles over the allocated PRACH resource via PRACH circuit 214 for channel access, where channel access is gained via random-access circuit 219, where the proposed two-phase backoff mechanism is applied for the channel access.

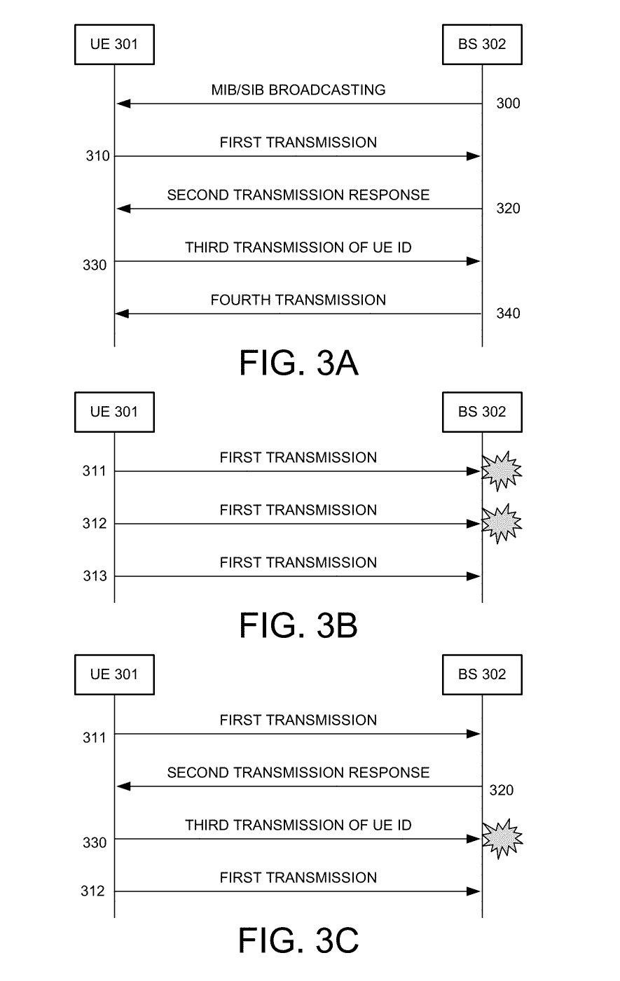

FIG. 3A illustrates an example of an access procedure in LTE networks. The notation “access procedure” is here used denoting a procedure to initiate wireless communication. An access procedure is used when a UE does not have a dedicated radio resource that it can use. Typically, the access procedure can only happen after a UE has received information and parameters related to access allowed by the receiving end. For LTE base stations such information can be provided by master information block or system information block (MIB/SIB) broadcast. The configuration information comprises PRACH resources, preambles, and backoff times. In one example, in step 300, BS 302 broadcast the MIB/SIB over a physical broadcast channel (PBCH).

In step 310, UE 301 performs a first transmission (message 1). Typically, such transmissions can occur simultaneously for several UEs in case of the circumstance that they decide to initiate an access procedure at the same time. UEs may also adjust the power used for the transmission based on estimated radio conditions, e.g. pathloss. In step 320, BS 302 then responds by a second transmission (message 2) to the UE(s) for which the first transmission could be correctly detected. For 3GPP LTE systems, the UE cannot attach sufficient information to identify itself with the first transmission. If this is the case, then UE 301 needs to provide unique identity information in a third transmission (message 3) (step 330). Only when the network has confirmed the reception of UE unique ID information in a fourth transmission (message 4) (step 340), contention between UEs initiating the procedure at the same time is resolved, and the access procedure is considered successful.

Note that the term “transmission” may on the physical layer (L1) be considered multiple transmissions, e.g. when repetition is used to achieve sufficient coverage. For example, some UEs, in the basements of residential buildings or locations shielded by foil-backed insulation, metalized windows or traditional thick-walled building construction, may experience significantly larger penetration losses on the radio interface than normal LTE devices. More resources/power are needed to support these UEs in the extreme coverage scenario. Repetition has been identified as a common technique to bridge the additional penetration losses than normal LTE devices. In another example, Machine-Type Communication (MTC) is an important revenue stream for operators and has a huge potential from the operator perspective. Lowering the cost of MTC user equipment (UEs) is an important enabler for the implementation of the concept of “Internet of Things” (IOT). The LC-MTC/UE has limited bandwidth which also requires L1 repeated transmission.

The invention herein is intended to cover also other kinds of access procedures, e.g. in cases when a UE can provide unique identity information already by the first transmission, contention can be resolved the procedure could end successfully already at the second message if the unique UE identity could be acknowledged there. There may also be cases when a unique UE identity can be inferred by a layer 1 identity or mapped to the usage of a certain radio resource, in which cases the procedure may be considered successful already at the reception of a response message. However, if the procedure is not successful, then UE 301 performs reattempts with a proposed two-phase backoff mechanism.

FIG. 3B illustrates a first example of an error case during a random-access procedure where reattempts are performed. UE 301 transmits the first transmission in step 311, but there is no reply from the other end, i.e. no response message 2 from BS 302. After a trigger, e.g. a certain amount of time, UE 301 transmits another first transmission in step 312, but again there is no reply from the other end, i.e. no response message 2 from BS 302. After a trigger, e.g. a certain amount of time, UE 301 transmits yet another first transmission in step 313. The sequence of reattempts may continue until there is a response and the procedure can conclude successfully, or until the UE gives up. In the context of this patent application, the term backoff is used, meaning the functionality that controls the triggering of reattempts to again transmit a first transmission to initiate communication—the first transmission of message 1 in an access procedure—the definition is slightly wider than in many other literatures, i.e., a random-access preamble or sequence transmission.

FIG. 3C illustrates a second example of an error case during a random-access procedure where reattempts are performed. UE 301 transmits the first transmission in step 311, the UE can detect a response of message 2 in step 320, and transmits the unique UE ID in step 330. However, there is no final confirmation that confirms the UE unique ID, i.e. no message 4 and the procedure cannot be considered successful. After a trigger, e.g. a certain amount of time, while the access procedure has not been successful, UE 301 transmits another first transmission in step 312. Note that in 3GPP LTE systems the backoff behavior is further controlled by a parameter received in message 2. The invention herein is intended to include both cases when backoff parameters or backoff triggers are provided by the network as well as the case when the backoff behavior is implemented locally in the UE.

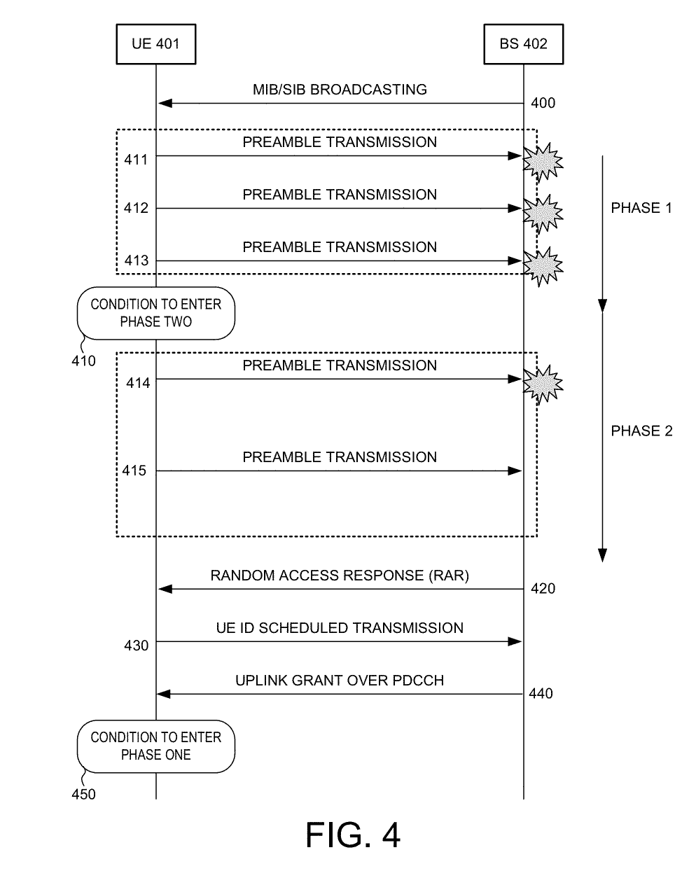

FIG. 4 illustrates a random-access procedure with two-phase backoff handling in accordance with a novel aspect of the present invention. A major reason why it is beneficial to have two phases is that a certain number of reattempts could be considered normal, in particular in the presence of power ramping where the UE starts attempting with a low power that is maybe set to be successful for a low interference level. Furthermore, other kinds of ramping (or parameter change) between transmission attempts could also be considered normal, e.g. increasing the number of repetitions for a transmission or even changing the signal waveform, beam forming pattern, to achieve higher robustness and better coverage. Such power or robustness ramping to compensate for variations in radio conditions, compensate for inaccuracy of the UE measurements by which it chooses the parameters for the very first transmission, could be considered normal and a normal character of wireless communication, regardless load conditions. For normal reattempts, a first phase of network-controlled backoff can be applied. During phase 1, UE specific variation in the backoff time between reattempts may be useful to avoid that the transmission attempts of certain UEs consistently collide.

However, at very high load conditions, e.g. stadium scenarios, the other end may be busy and choose to not respond to all access attempts because of load. Such scenarios may result in a very long sequence of reattempts and UE transmissions. For 3GPP LTE, 100's of transmissions or attempts could be possible, leading to further worsening of the load and interference situation. To alleviate this, there should be a mechanism such that the UE can re-attempt at a lesser rate. To address these two cases, the “normal” reattempt case, and the “other end busy” reattempt case it is here proposed to have a two phase back-off mechanism. In the first phase, reattempts due to collisions, ramping of power and other robustness parameters needed to compensate for unpredictable conditions can be handled. In the second phase, UE-controlled reattempts can continue, assuming that the continuation is needed due to the other end being busy.

In the example of FIG. 4, in step 400, BS 402 broadcast the MIB/SIB over a physical broadcast channel (PBCH) to all UEs including UE 401. The broadcast configuration information comprises PRACH resources, preambles, and backoff times for random-access procedures. In step 411, UE 401 starts a random-access procedure by transmitting a random-access preamble to BS 402. Assume BS 402 is not able to decode the preamble due to collision or error and does not send a response back to UE 401. UE 401 then starts phase-1 backoff and performs normal reattempts based on network provided backoff times. UE 401 again transmits a random-access preamble in step 412 and step 413 after a first backoff time if the previous attempt fails. At certain point, UE 401 determines that a condition to enter phase-2 has been satisfied (step 410). The condition may include at least one of or any combination of the following conditions: 1) Power ramping is finished, e.g. when max power has been achieved; 2) Other robustness ramping is finished, e.g. when max number of Repetitions has been achieved (e.g. for the particular radio conditions); 3) A certain number of attempts N has been performed, where N may be configurable; 4) A certain time has passed, e.g. counted as absolute time, Number of radio frames (or sub-frames etc.), or as Number of radio resource opportunities; 5) An explicit backoff indication from the BS is received by the UE.

UE 401 then enters phase-2 backoff for the random-access procedure based on UE-determined backoff times. In step 414 and step 415, UE 401 again transmits a random-access preamble after a second backoff time when the previous attempt fails. The second backoff time is randomly chosen based on a parameter, e.g. equal probability between a min value and a max value. In one example, the max value is determined by a function of time T, i.e. the time elapsed since the start of the phase-2, and where the max value increases as T increases, and where T may be measured either in elapsed time (seconds, milliseconds etc.), in elapsed radio frames (number N), or in elapsed Number of radio resource opportunities (e.g. PDCCH occasions, PRACH resource occasions, Access Resource opportunity, Transmission Time Interval—TTI).

In step 420, UE 401 finally receives a random-access response (RAR) message 2 from BS 402. In step 430, UE 401 provides unique identity information in message 3. Only when the network has confirmed the reception of UE unique ID information and provided with an uplink grant to UE in message 4 (step 440), contention between UEs initiating the procedure at the same time is resolved, and the access procedure is considered successful. Later on, in step 450, UE determines to go back to the first phase if one or more of the following conditions are met: 1) UE reselects to a new cell; and 2) UE leaves RRC Connected mode and enters RRC Idle mode.

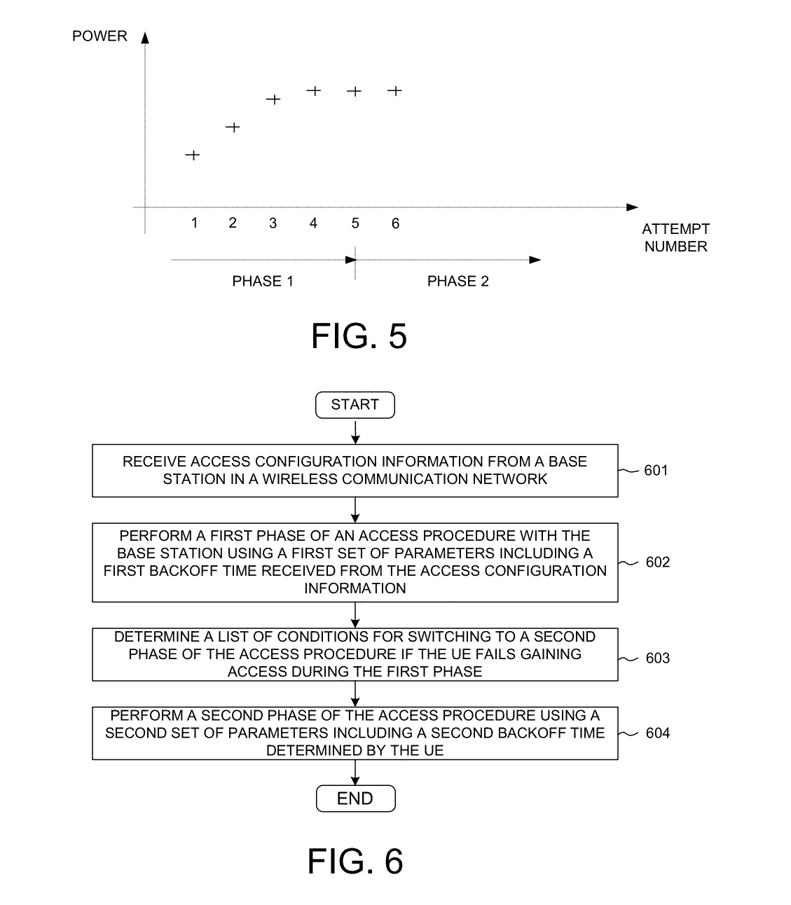

FIG. 5 illustrates different examples of triggering conditions for a UE switching from phase-1 to phase-2 backoff handling. Initially, the UE makes a first access attempt at a certain initial power level, which might be based on a UE pathloss estimate. For each subsequent attempt, the UE increases the output power until a maximum is reached, which may be a configured maximum or the maximum power according to UE capability. This process is called power ramping. In the example of FIG. 5, the max power is reached at attempt number 4. After reaching max power, the UE can go into phase-2, with a slower re-attempt cycle, e.g., a longer backoff time. In the example this happens at/after attempt number 5. This behavior could be achieved in several ways. The most straight-forward way may be to have a rule or configuration that prescribes that phase-1 ends or phase-2 starts when max power has been reached. However, in some circumstances the initial power used by the UE may be very high, maybe even max. Therefore, to allow for collision reattempts in phase-1, another possibility is to just configure a repetition number N, as the end of phase-1 and/or the start of phase-2, and set power ramping parameters such that power ramping is finished when attempt N occurs. Similarly, other resources can change configuration as the UE makes the access attempts, e.g. number of Ll repetitions can increase (higher number of repetitions for higher robustness—a kind of robustness ramping), and the criterion to stop phse-1 or start phase-2 could be the finalization of the robustness ramping.

FIG. 6 is flow chart of a method of two-phase backoff handling for access procedures in accordance with one novel aspect. In step 601, a UE receives access configuration information from a base station in a wireless communications network. In step 602, the UE performs a first phase of an access procedure with the base station using a first set of parameters including a first backoff time received from the access configuration information. In step 603, the UE determines a list of conditions for switching to a second phase of the access procedure if the UE fails gaining access during the first phase. In step 604, the UE performs a second phase of the access procedure using a second set of parameters including a second backoff time determined by the UE.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving access configuration information from a base station by a user equipment (UE) in a wireless communications network;
performing a first phase of an access procedure with the base station using a first set of parameters including a first backoff time received from the access configuration information;
determining a list of conditions for switching to a second phase of the access procedure if the UE fails gaining access during the first phase; and
performing a second phase of the access procedure using a second set of parameters including a second backoff time determined by the UE.

2. The method of claim 1, wherein the access procedure involves sending a random-access preamble to the base station over a physical random-access channel (PRACH) and reattempts with backoff upon failure.

3. The method of claim 2, wherein the access configuration information comprises a plurality of preambles and a set of PRACH radio resources.

4. The method of claim 1, wherein the list of conditions comprises whether a power ramping is finished by reaching a maximum power threshold.

5. The method of claim 1, wherein the list of conditions comprises at least one of a number of reattempts has been performed, a time has passed, a number of radio frames or subframes has elapsed, and a number of radio resource opportunities has reached.

6. The method of claim 1, wherein the list of conditions comprises the UE receiving a backoff indication from the base station.

7. The method of claim 1, wherein the UE applies configured, signaled or derived parameters for random access procedure only in the second phase.

8. The method of claim 1, wherein the second backoff time is randomly chosen between a min value and a max value by the UE.

9. The method of claim 8, wherein the max value is a function of at least one of an elapsed time, a number of elapsed radio frames or subframes, and a number of elapsed radio resource opportunities from the start of the second phase.

10. The method of claim 1, wherein the UE switches back to the first phase of access procedure when at least one of the conditions is satisfied: the UE reselects to a new serving cell, and the UE enters an idle mode.

11. A User Equipment (UE) comprising:
a radio frequency (RF) receiver that receives access configuration information from a base station in a wireless communications network;
a channel access handling circuit that performs a first phase of an access procedure with the base station using a first set of parameters including a first backoff time received from the access configuration information;
a configuration circuit that determines a list of conditions for switching to a second phase of the access procedure if the UE fails gaining access during the first phase; and
the channel access handling circuit that performs a second phase of the access procedure using a second set of parameters including a second backoff time determined by the UE.

12. The UE of claim 11, wherein the access procedure involves sending a random-access preamble to the base station over a physical random-access channel (PRACH) and reattempts with backoff upon failure.

13. The UE of claim 12, wherein the access configuration information comprises a plurality of preambles and a set of PRACH radio resources.

14. The UE of claim 11, wherein the list of conditions comprises whether a power ramping is finished by reaching a maximum power threshold.

15. The UE of claim 11, wherein the list of conditions comprises at least one of a number of reattempts has been performed, a time has passed, a number of radio frames or subframes has elapsed, and a number of radio resource opportunities has reached.

16. The UE of claim 11, wherein the list of conditions comprises the UE receiving a backoff indication from the base station.

17. The UE of claim 11, wherein the UE applies configured, signaled or derived parameters for random access procedure only in the second phase.

18. The method of claim 11, wherein the second backoff time is randomly chosen between a min value and a max value by the UE.

19. The UE of claim 18, wherein the max value is a function of at least one of an elapsed time, a number of elapsed radio frames or subframes, and a number of elapsed radio resource opportunities from the start of the second phase.

20. The UE of claim 11, wherein the UE switches back to the first phase of the access procedure when at least one of the conditions is satisfied: the UE reselects to a new serving cell, and the UE enters an idle mode.
